(19) United States
(12) Patent Application Publication
(10) Pub. No.: US 2026/0208034 A1
(43) Pub. Date: Jul. 23, 2026

(54) PICKUP ARM FOR PRIZE GAME MACHINE

(71) Applicant: SAFARI GAMES CO., LTD., Osaka (JP)

(72) Inventor: Nobuhiro OKA, Osaka (JP)

(21) Appl. No.: 19/566,569

(22) Filed: Mar. 13, 2026

Related U.S. Application Data
(63) Continuation of application No. PCT/JP2024/002690, filed on Jan. 29, 2024.

(30) Foreign Application Priority Data
Sep. 15, 2023 (JP) 2023-149918

(51) Int. Cl. A63F 9/30; G07F 17/32

(52) U.S. Cl. CPC A63F 9/30; G07F 17/3297

(57) ABSTRACT

A pickup arm includes an elevatable member movable in an up-down direction. A pressing portion is provided at a bottom of the elevatable member to contact and rotate an arm in an opening direction. A shelf is formed at a middle position of the elevatable member. A pin member having a brim is loosely held by the shelf. A bottom end of the pin member and a pressed portion of the arm are coupled by a tension spring. The pickup arm is configured such that the arm, pivoted in a closing direction by a rise of the elevatable member, has a gripping force made larger than a gripping force provided by a weight thereof. This is a result of the tension spring being extended by an upward movement of the pin member caused by a further rise of the elevatable member.

### TECHNICAL FIELD

The present invention relates to a prize game machine allowing a prize accommodated in a game space of a housing to be acquired by an operation performed externally.

### BACKGROUND ART

A pickup arm including a plurality of pivotable arms is provided as a device making an operation on a prize or a member supporting the prize.

As disclosed in Patent literature 1 mentioned below, a pickup arm is attached to a tip of a hanging wire or the like, and is configured to be movable in a front-rear direction and a left-right direction in a game space and to be movable in an up-down direction. A body case is formed to be cylindrical. Arms are provided to be pivotable by an annular attachment base provided at a middle position, in the up-down direction, of an outer circumferential surface of the body case and an arm attachment portion provided below the body case so as to be movable in the up-down direction. That is, the attachment base includes protrusions provided by the same number as that of the arms, and the protrusions protrude outward. A pivot support portion is pivotably supported at each of the protrusions, and a base portion of each of the arms is rotatably supported at a bottom end of the pivot support portion. The arm attachment portion is provided at a bottom end of a cylinder, and supports the base portions of the arms such that the base portions are rotatable. The cylinder is driven by a motor, accommodated in the body case, to advance from, or retract toward, a bottom surface of the body case.

The pickup arm having such a configuration operates as follows. When the motor is driven to protrude the cylinder and lower the arm attachment portion, the arms pivot in an opening direction. By contrast, when the cylinder is retracted to raise the arm attachment portion, the arms pivot in a closing direction. That is, a motion of gripping a prize is made by upward and downward movements of the arm attachment portion based on the driving of the motor.

The arms make a gripping motion. For gripping, the plurality of arms start moving at the same time. This is a mechanical motion and is not entertaining.

By contrast, Patent Literature 2 mentioned below discloses a pickup arm that includes arms opening and closing independently and is capable of adjusting gripping forces thereof.

This pickup arm includes a solenoid, provided for each of the arms, controlling opening and closing motions of the arm, and also includes a driving source adjusting the gripping forces. That is, the driving source is provided at a center of a housing of the pickup arm, and the solenoids are located around the driving source. An actuator protruding from a bottom end of each of the solenoids is connected with a base portion of the corresponding arm via a spring. A bottom end of the spring is connected at a position, in a base end portion of the arm, that is outer to a pivot portion. By contrast, a nut member movable in an up-down direction is provided on an output shaft of the driving source. The nut member movable in the up-down direction is provided with a tip end of a spring, different from the above-mentioned spring. The tip end of the spring is provided in correspondence with each of the arms. A bottom end of this spring is connected with the arm at a position, in the base end portion of the arm, that is inner to the pivot portion.

The pickup arm having such a configuration opens and closes the arms independently by the solenoid provided for each of the arms, and also adjusts an amount by which the spring is to be pulled by the driving source, and thus adjusts the gripping strength of the arm.

However, the pivoting motions of the arms are to realize a game in which, for example, a plurality of arms grip and lift a prize and then the arm selected by the player is opened, so that the prize is carried by a small number of, for example, two, arms while the balance is adjusted. This is to realize a certain type of game, and does not add any new taste to the manner of gripping.

In addition, the pickup arm in Patent Literature 2 requires a solenoid (driving source) for each of the arms, and also requires a driving source to adjust the gripping force. A large number of driving sources are necessary.

### CITATION LIST

### PATENT LITERATURE

Patent Literature 1: Japanese Patent No. 6925659

Patent Literature 2: Japanese Registered Utility Model No. 3095996

### SUMMARY OF INVENTION

### TECHNICAL PROBLEM

The present invention has a main object of providing a new taste to a motion of closing an arm and decreasing the number of actuators usable for driving to simplify the configuration.

### SOLUTION TO PROBLEM

For this purpose, the present invention provides the following pickup arm for a prize game machine, the pickup arm including an arm supported at a pivot portion on the side of a base portion thereof and including a tip pivotable in an opening direction and a closing direction.

The pickup arm includes an elevatable member movable in an up-down direction. A pressing portion contacting, from above, a pressed portion, of an arm, that is on the side of a base end with respect to a pivot portion to rotate the arm in an opening direction is provided in a bottom portion of the elevatable member so as to protrude toward the arm. A shelf is formed at a middle position, in the up-down direction, of the elevatable member, the shelf having a space located above the shelf and a space located below the shelf, the shelf being provided in correspondence with the arm. A pin member is loosely held by the shelf, the pin member having a brim at a top end thereof and being prevented from being pulled to an area below the shelf, the brim protruding outward. A bottom end of the pin member and a position adjacent to the pressed portion of the arm are coupled to each other by a tension spring. The pickup arm is configured such that the arm pivoted in a closing direction by a rise of the elevatable member has a gripping force thereof made larger than the gripping force provided by a weight thereof, as a result of the tension spring being extended by an upward movement of the pin member, which is caused by a further rise of the elevatable member.

According to this configuration, the motion and provision of the gripping forces required to pickup the prize are provided by merely the elevatable member being moved up and down. This will be described more specifically. After being in a wait state where the elevatable member presses the pressed portion of the arm appropriately, the pickup arm starts the motion of picking up the prize, and the elevatable member is raised. In the case where a plurality of the arms are provided, the arms are independently moved to be closed. From this state, the elevatable member is further raised to a predetermined level, the brim of the pin member is hooked at the shelf to extend the tension spring and thus to accumulate the gripping force. At this point, if the prize is gripped, the arm maintains the accumulated gripping force. If the prize is not gripped, the pin member and the tension spring put the arm into a free state. Therefore, the arm is pivoted into a state of being closed by the weight thereof. In the state of being closed by the weight thereof, the arm lifts the tension spring and the pin member. Therefore, the pin member separates the brim away from the shelf and is floating in the air. In either case, the elevatable member is lowered at a position where the prize is to fall, and the pressing portion presses the pressed portion to open the arm to the maximum possible degree. In the former case, if the prize is still gripped at this point, the prize falls. Then, the elevatable member is raised by a predetermined distance to be put into the above-mentioned wait state, and the above-described motion is repeated.

### ADVANTAGEOUS EFFECTS OF INVENTION

According to the present invention, the pickup arm is configured such that in a step of raising the elevatable member to close the arm, the brim of the pin member is hooked at the shelf to extend the tension spring. Therefore, in a state before the tension spring is caused to exhibit the stress to close the arm while the arm has the gripping force, the arm moves in accordance with the situation. In the case where a plurality of arms are provided, the arms do not necessarily start moving in the closing direction at the same time, but move independently. Therefore, the arm may move more naturally to grip the prize. Thus, the motion of closing the arms may have a new taste.

The pickup arm is configured such that the gripping force of the arm is provided by pulling the pin member, in a step of moving upward to close the arm, to extend the tension spring. Therefore, the gripping force may be provided together with the motion of closing the arm while the elevatable member is moved upward. Thus, there is no need to provide a driving source to provide the gripping force separately from the driving source to open and close the arm. This simplifies the configuration and decreases the size.

The driving source merely needs to move the elevatable member up and down. Therefore, for example, one motor is sufficient. Therefore, the configuration of the pickup arm is significantly simplified, which is superb to decrease the size.

### BRIEF DESCRIPTION OF DRAWINGS

FIG. 1 is a perspective view of a main portion of a pickup arm.

FIG. 2 is a plan view of the pickup arm.

FIG. 3 is a view illustrating a configuration in a state where the pickup arm is taken along line A-A in FIG. 2.

FIG. 4 is a view illustrating a configuration in a state where arms are opened to a maximum possible degree.

FIG. 5 is a view illustrating a configuration in a state where the arms having weights thereof are left with no operation added thereto.

FIG. 6 is a view generally showing a change in the level of an elevatable member at each of stages of a motion of the pickup arm.

FIG. 7 is a view illustrating a configuration showing a state of arms and the like at a wait time.

FIG. 8 shows states of the arms and the like at the wait time and a stage of starting a grip.

FIG. 9 shows states of the arms and the like at the stage of starting the grip and a stage of exhibiting a gripping force.

FIG. 10 shows a motion made when the grip is successful.

FIG. 11 shows a motion made when the grip fails.

FIG. 12 is a view showing a configuration of a pickup arm including a motor at a different position.

### DESCRIPTION OF EMBODIMENTS

Hereinafter, an embodiment of the present invention will be described with reference to the drawings.

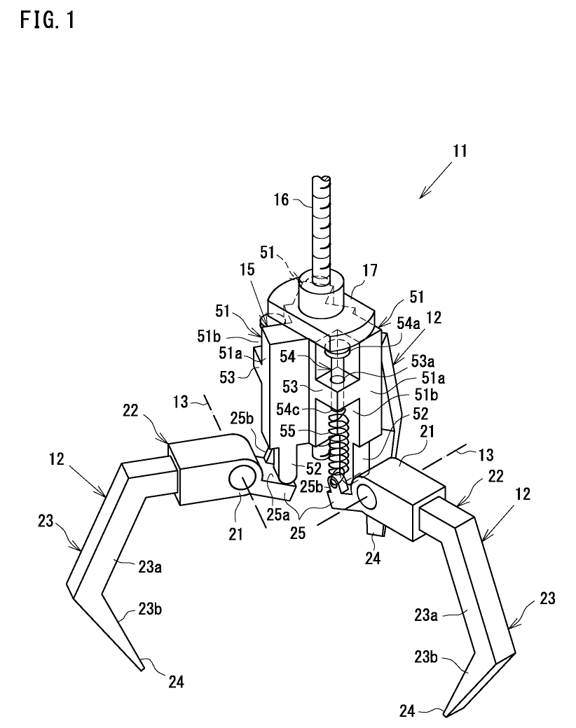

FIG. 1 is a perspective view of a main portion of a pickup arm 11 in a prize game machine (not shown). The pickup arm 11 forms a tip of a crane of a so-called crane game, and includes a plurality of, more specifically, three, arms 12 so as to allow a prize to be gripped directly. The arms 12 are each supported such that a base portion thereof is rotatable, and a tip portion of each of the arms 12 is pivotable in an opening direction and a closing direction. In FIG. 1, reference sign 13 represents a pivot axis around which the base portion of each of the arms 12 is rotatably supported.

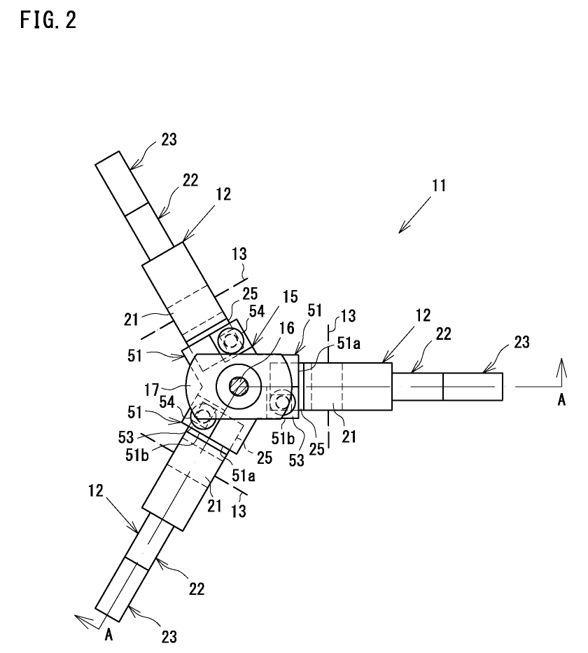

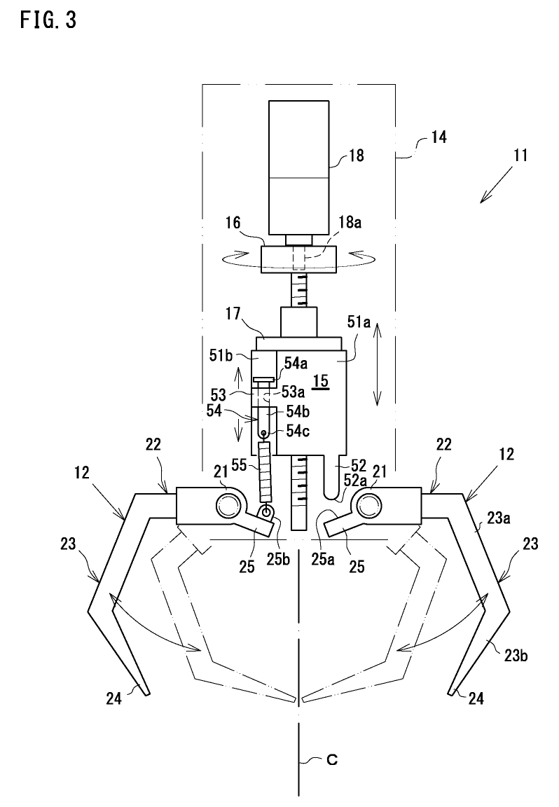

As shown in FIG. 2, which is a plan view, the three arms 12 are located at an equidistantly. Therefore, the configuration of the pickup arm 11 is difficult to understand as seen in a front view or a side view. Thus, the following explanation will be made with reference to FIG. 3, in which two arms 12 are shown in a bilateral symmetrical manner. FIG. 3 and the like, in which the arms 12 are shown in a bilateral symmetrical manner, are taken along line A-A in FIG. 2. Hatching representing a cross-section is omitted for the sake of simplicity.

As shown in these figures, the pickup arm 11 includes an elevatable member 15 movable in an up-down direction in a housing 14. In order to move the elevatable member in the up-down direction, a screw shaft 16 extending in the up-down direction is supported in the housing 14, and a leadscrew nut 17 is held by the screw shaft 16 and is movable in a longitudinal direction (up-down direction) along with forward and reverse rotations of the screw shaft 16. The elevatable member 15 is secured below the leadscrew nut 17. In order to rotate the screw shaft 16 forward and rearward, a rotation shaft 18a of a motor 18 rotatable forward and rearward is connected to a top end of the screw shaft 16. The motor 18 is a stepping motor, a servo motor or the like, and is located on the same axial line as that of the screw shaft 16. The motor 18 is located on the same axial line as that of the screw shaft 16, so that the housing 14 may have a minimum possible diameter. Although not shown, necessary devices such as, for example, a sensor sensing the position at which the motor 18 stops and a sensor sensing the rotation rate of the motor 18 are provided.

The elevatable member 15 is formed to have a generally polygonal prism shape, and has the screw shaft 16 passing at a center thereof as seen in a plan view. The elevatable member 15 includes protrusions 51 at positions of every 120 degrees on an outer circumferential surface thereof. The protrusions 51 are associated with the arms 12. The protrusions 51 are each divided into two portions in a width direction. One of the two portions is an opening operation portion 51a, and the other of the two portions is a pin holding portion 51b. The protrusions 51 each including the opening operation portion 51a and the pin holding portion 51b are located at three positions equidistantly in correspondence with the arms 12. The three arms 12 are configured to be openable and closable independently from each other.

The opening operation portion 51a has a pressing portion 52 protruding from a bottom surface thereof. The pressing portion 52 is log-like, and contacts a portion of the corresponding arm 12 from above to rotate the arm 12 in the opening direction. The portion of the arm 12 contacted by the pressing portion 52 is on the side of a base end with respect to a pivot portion 21, which is supported by the housing 14.

Now, the arms 12 will be described.

Each of the arms 12 includes the above-described pivot portion 21 on the side of the base end. The pivot portion 21 is rotatably supported. Each arm 12 includes a base end portion 22 including the pivot portion 21, an arm tip 24 extending in a direction different from the base end portion 22, and a bent portion 23 located between the base end portion 22 and the arm tip 24. The arm 12 is shaped and the pivot portion 21 is positioned in the arm 12 such that when the arm 12 is hung by a weight thereof with the pivot portion 21 being used as the fulcrum, the arm tip 24 approaches a phantom central line C (see FIG. 3) extending in the up-down direction of the pickup arm 11.

The arms 12 will be described more specifically. The base end portion 22 of each arm 12 is formed to be linear. When the base end portion 22 is located horizontally, the bent portion 23 includes an outward inclining portion 23a extending obliquely outward while extending downward and an inward inclining portion 23b extending obliquely inward while extending downward. The inward inclining portion 23b is shorter than the outward inclining portion 23a, and has a length with which when the base end portion 22 assumes an attitude close to a horizontal attitude, a space in which a prize is housed is formed inner to the arm tip 24. A tongue 25 is provided on the side of the base end with respect to the pivot portion 21. The tongue 25 is like a flat plate, and extends obliquely downward when the base end portion 22 is located horizontally. One of two portions of the tongue 25 in the width direction is a pressed portion 25a, which contacts the pressing portion 52 provided on the opening operation portion 51a of the elevatable member 15. The other of the two portions of the tongue 25 is a portion corresponding to the pin holding portion 51b of the elevatable member 15, and has a hold portion 25b protruding from a top surface thereof.

The tongue 25 including the pressed portion 25a of the arm 12 is like a flat plate. The pressing portion 52 of the elevatable member 15 has an arc surface 52a formed at a bottom end thereof. The arc surface 52a protrudes downward in an arc shape.

A shelf 53 is formed at a middle position in the up-down direction of the pin holding portion 51b of the elevatable member 15. The shelf 53 has a space above the shelf 53 and a space below the shelf 53. The shelf 53 has a through-hole 53a, formed therein, running therethrough in a thickness direction thereof, and a pin member 54 is loosely held in the through-hole 53a. At a top end of the pin member 54, a brim 54a is formed. The brim 54a has a diameter larger than that of the through-hole 53a, and extends outward. The brim 54a is thinner than the height of the space above the shelf 53. A shaft portion 54b below the brim 54a is longer than the thickness of the shelf 53. The shaft portion 54b has a length that is set such that when the pin member 54 is raised to a highest possible level with respect to the elevatable member 15, a bottom end portion 54c protrudes into the space below the shelf 53. That is, the pin member 54 moves a portion, of the shaft portion 54b, that is above the bottom end portion 54c with respect to the through-hole 53a of the shelf 53, moves the brim 54a in the up-down direction in the space above the shelf 53, and is prevented from being pulled to an area below the shelf 53.

A tension spring 55 is coupled between the bottom end portion 54c of the pin member 54, and a position adjacent to the pressed portion 25a of the arm 12, that is, the hold portion 25b. The tension spring 55 is a coil spring, and when being pulled by a certain force, generates a stress (repulsive force) to contract.

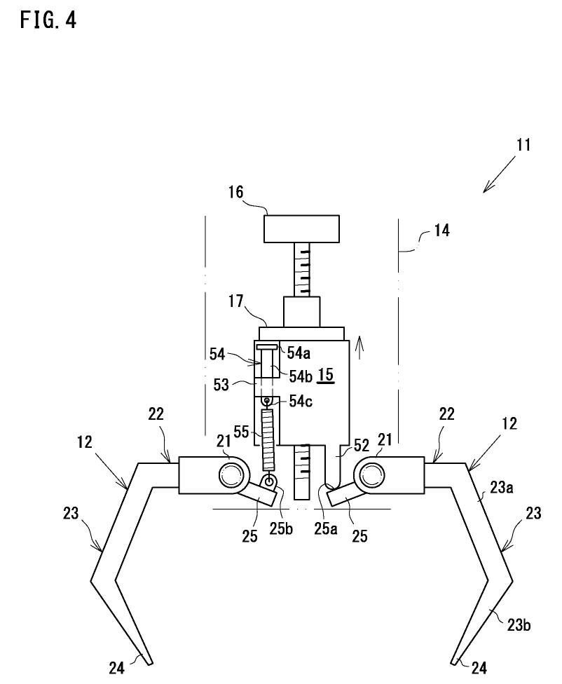

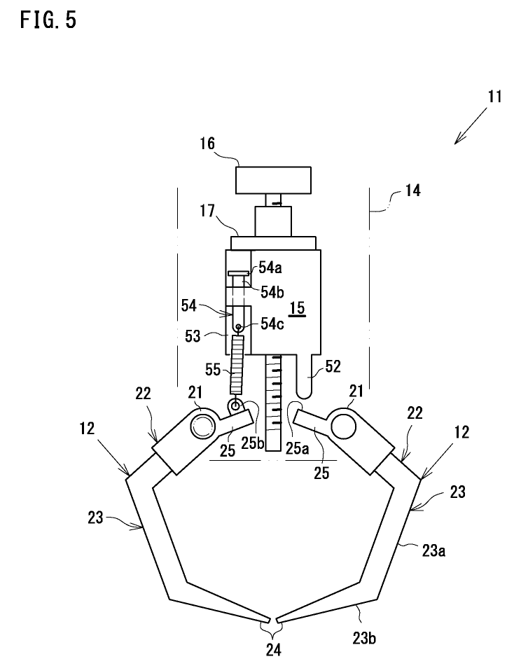

The length and the like of the tension spring 55 and the members in the vicinity thereof have the following relationship. As shown in FIG. 4, when the elevatable member 15 is lowered and the base end portions 22 of the arms 12 are made horizontal to open the arms 12 to a maximum possible degree, the tension spring 55 having a natural length presses up the pin member 54 to locate the brim 54a of the pin member 54 at a top end of the space above the shelf 53. As shown in FIG. 5, when the elevatable member 15 is raised and the arms 12 are put into a natural state, in which the arms 12 are each pivoted by the weight thereof and hung, that is, into a free state, in which the arms 12 each have a gripping force by the weight thereof, the tension spring 55 having the natural length presses up the pin member 54. At this point, the brim 54a is located at a middle position, in the up-down direction, of the space above the shelf 53. The pickup arm 11 is configured such that the arms 12 pivoted in the closing direction by the rise of the elevatable member 15 each make the gripping force thereof larger than the gripping force provided by the weight thereof. The gripping force of each arm 12 is made larger as described above, as a result of the tension spring 55 being extended. The tension spring 55 is extended because the pin member 54 is moved upward, which is caused by a further rise of the elevatable member 15.

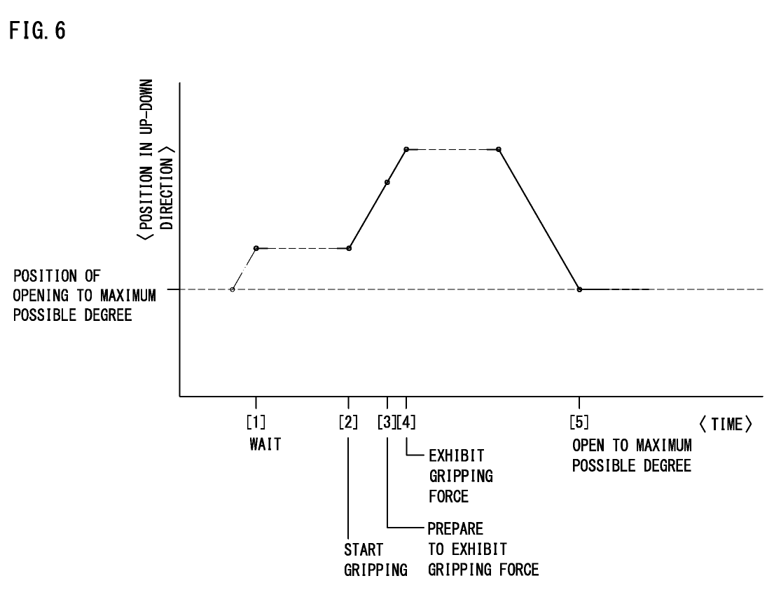

A series of motions of the pickup arm 11 from gripping a prize until releasing the prize may be conceptually shown in FIG. 6. In FIG. 6, the vertical axis represents the position of the elevatable member 15 in the up-down direction, and the horizontal axis represents the time. A motion of gripping and then releasing the prize is made and a gripping force is provided during a movement of one stroke in which the elevatable member 15 is raised and lowered.

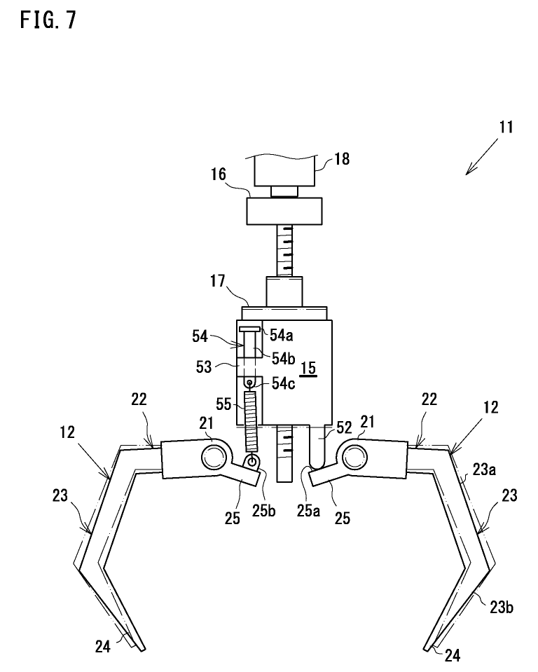

The motion is specifically as follows (see FIG. 7 through FIG. 11).

At the wait time and at the start of the game ([1]), as shown in FIG. 7, the elevatable member 15 is at a level higher than a level thereof when the arms 12 are opened to the maximum possible degree (see the phantom line) in order to cause the arms 12 to each close and have an angle smaller than an angle thereof when the arms 12 are opened to the maximum possible degree. At this point, each of the pressing portions 52 provided on the elevatable member 15 presses down the pressed portion 25a of the corresponding arm 12.

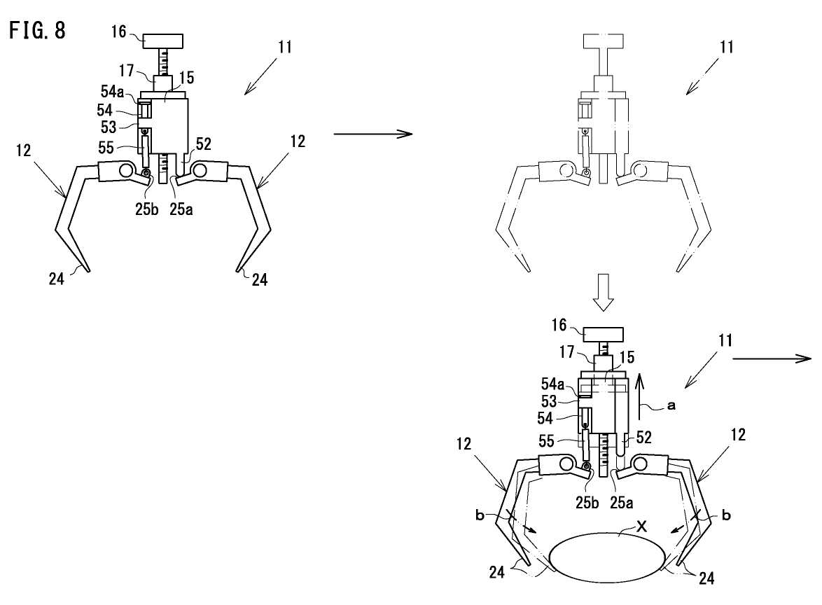

When a switch to start a game is operated on and as shown in FIG. 8, the pickup arm 11 is moved in the horizontal direction, stops at a position determined by a player and is lowered, a gripping operation is started at that position (prize X position) ([2]). First, the motor 18 is driven to rotate the screw shaft 16 by a predetermined amount, and thus the elevatable member 15 is raised (arrow a). When necessary, the arms 12 are closed to have a minimum possible angle (arrow b) along with the rise of the pickup arm 11. At this point, the elevatable member 15 is raised regardless of the level of the pin members 54, without the tension springs 55 being extended. The gripping forces of the three arms 12 are provided by the weights thereof. The arms 12 each attempt to pivot in the closing direction at a weak force in accordance with the state of the portion contacting the arm tip 24, for example, whether or not the arm tip 24 contacts one prize X, whether or not the arm tip 24 contact another prize X, or the like. In other words, the elevatable member 15 is raised until each of the shelves 53 approaches, or contacts, the corresponding brim 54 of the pin member 54, which is not moved even though the elevatable member 15 is moved. This is a preparation step for causing the arms 12 to exhibit the gripping forces thereof ([3]).

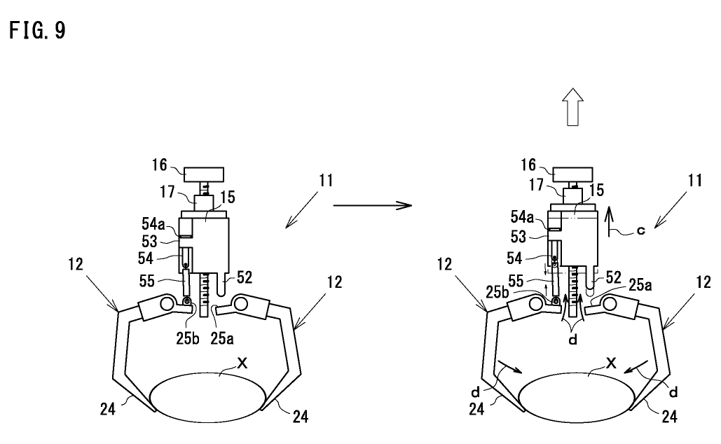

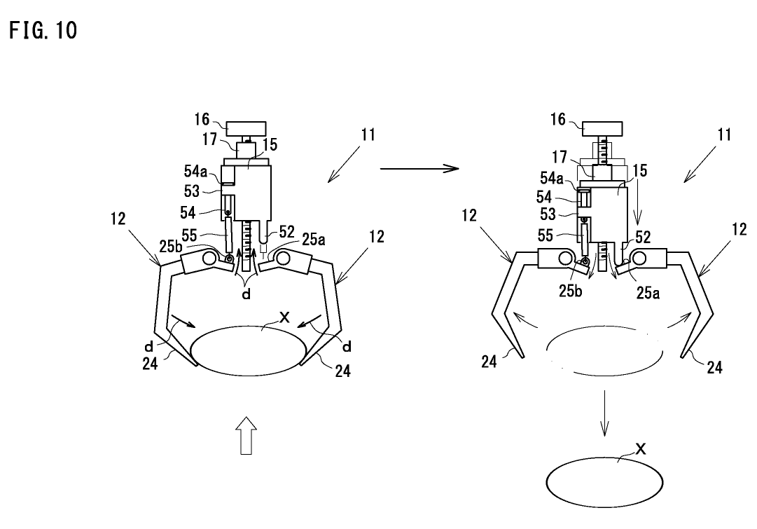

Next, as shown in FIG. 9, the elevatable member 15 is further raised by a predetermined amount (to a predetermined level) (arrow c). This is a step for causing the arms 12 to exhibit the gripping forces thereof ([4]). As a result of such a further rise of the elevatable member 15, the brim 54a of each of the pin members 54 hooks and extends the corresponding tension spring 55 in the shelf 53, and this supplies the arms 12 with gripping forces required for the arms 12 to grip the prize X (arrow d). The gripping forces may be changed by the amount by which the elevatable member 15 is raised. In the case where the prize X is gripped when the gripping forces are exhibited, the gripping forces are maintained when the pickup arm 11 are to be raised thereafter or when the pickup arm 11 is to be moved in the horizontal direction after being raised (left in FIG. 10).

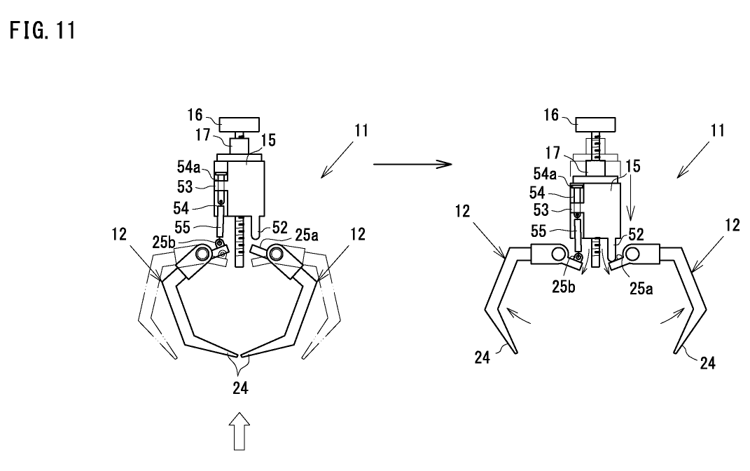

By contrast, in the case where the prize X is not gripped, that is, in the case where the arms 12 fail to grip the prize X and the prize X is disengaged from the arms 12, the arms 12 pivot to close positions by the weights thereof. That is, as shown in FIG. 5, the arms 12 are put into a state of being closed by the weights thereof, in which the arm tips 24 are close to the phantom central line C extending in the up-down direction of the pickup arm 11 (left in FIG. 11). At this point, the arms 12 lift the tension springs 55 and the pin members 54, and each pin member 54 separates the brim 54a away from the corresponding shelf 53 and is floating in the air.

In the former case, that is, in the case where the arms 12 grip the prize X, when the arms 12 keep on gripping the grip X and move to a release point, as shown in the right part of FIG. 10, the elevatable member 15, which has been raised intermittently, is lowered to a lowest possible position thereof to open the arms 12 to the maximum possible degree ([5]). As a result, the prize X that has been held falls and is taken to the outside of the game machine. In the latter case, that is, in the case where the arms 12 fail to grip the prize X, the pickup arm 11 moves to the release point while the arms 12 are in the state of being closed by the weights thereof as shown in the left part of FIG. 11 and lowers the elevatable member 15 to the lowest possible position thereof as shown in the right part of FIG. 11. As a result, the arms 12 are opened to the maximum possible degree like in the case where the arms 12 grip the prize X ([5]).

After this, as represented by the solid line in FIG. 7, the elevatable member 15 are slightly raised while the arms 12 are opened to the maximum possible degree, so that the above-described wait state ([1]) is realized. Thus, the pickup arm 11 waits for the start of the next game.

As described above, the motion and provision of the gripping forces required to pickup the prize are provided by merely the elevatable member 15 being moved up and down. This simplifies the configuration and decreases the size, and also makes the provision and control of the gripping forces easy. In addition, the elevatable member 15 is formed of the screw shaft 16 and one motor 18 rotating the screw shaft 16 forward and rearward. This significantly simplifies the configuration of the elevation member 15, and allows the elevation member 15 to be controlled easily with certainty.

The shape of each arm 12 and the position of the pivot portion 21 in the arm 12 are set such that when the arm 12 is hung by a weight thereof with the pivot portion 21 being used as the fulcrum, the arm tip 24 approaches the phantom central line C of the pickup arm 11. Therefore, the configuration in which the arms 12 are put into the state of being closed by the weights thereof may be effectively utilized to cause the arms 12 to make the gripping motion. This also simplifies the configuration. In addition, in the case where the prize X cannot be gripped, the arms 12 are immediately closed with the weighs thereof. Therefore, the player does not have an impression that the arms 12 have intentionally failed to grip the prize X. This promotes the player's willingness to play.

Regarding the gripping motion of the arms 12, the pin members 54 are loosely held by the elevatable member 15, and the base end of each arm 12 is connected with the pin member 54 via the tension spring 55. In this manner, the stage where the tension spring 55 is to be extended, and the stage where the tension spring 55 is not to be extended, are switched to each other. Therefore, the plurality of arms 12 start closing at the same time before the stress is generated in the tension spring 55, but the arms 12 each make an independent movement in accordance with the situation. In the case where each tension spring 55 is to act to cause the corresponding arm 12 to exhibit the gripping force, the arm 12 positively makes a motion of closing. As a result, each arm 12 may make a natural gripping motion by an independent movement, and the motion of closing of the arm 12 provides a new taste. This motives the player to play.

The above-described configuration is merely of one embodiment to carry out the present invention. The present invention is not limited to having the above-described configuration, and any other configuration may be adopted.

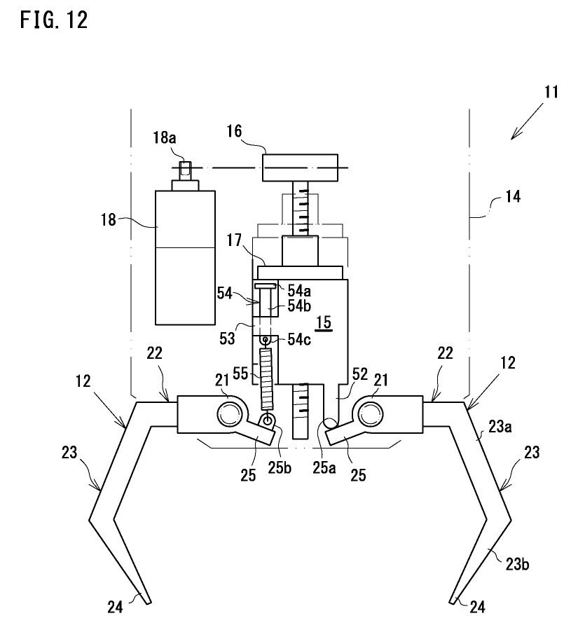

For example, as shown in FIG. 12, the motor 18 may be located parallel to the screw shaft 16. The motor 18 is located between the protrusions 51. Such a configuration is favorable in the case where the height of the pickup arm 11 is to be lowered or in the case where there is not problem even if the pickup arm 11 has a larger diameter. In FIG. 12, the elements having the same functions as those described above bear the same reference signs, and descriptions thereof are omitted.

Only one arm 12 may be provided.

The arms 12 may have a shape different from the above-described shape, for example, may be L-shaped or C-shaped as seen in a side view.

### REFERENCE SIGNS LIST

11 ... pickup arm

12 ... arm

15 ... elevatable member

16 ... screw shaft

18 ... motor

21 ... pivot portion

25a ... pressed portion

51 ... protrusion

51a ... opening operation portion

51b ... pin holding portion

52 ... pressing portion

53 ... shelf

54 ... pin member

54a ... brim

54c ... bottom end portion

55 .. .tension spring

1. A pickup arm for a prize game machine, the pickup arm including an arm supported at a pivot portion on the side of a base portion thereof and including a tip pivotable in an opening direction and a closing direction,
the pickup arm comprising an elevatable member movable in an up-down direction,
wherein:
a pressing portion contacting, from above, a pressed portion, of the arm, that is on the side of a base end with respect to the pivot portion to rotate the arm in the opening direction is provided in a bottom portion of the elevatable member so as to protrude toward the arm,
a shelf is formed at a middle position, in the up-down direction, of the elevatable member, the shelf having a space located above the shelf and a space located below the shelf, the shelf being provided in correspondence with the arm,
a pin member is loosely held by the shelf, the pin member having a brim at a top end thereof and being prevented from being pulled to an area below the shelf, the brim protruding outward,
a bottom end of the pin member and a position adjacent to the pressed portion of the arm are coupled to each other by a tension spring, and
the pickup arm is configured such that the arm pivoted in the closing direction by a rise of the elevatable member has a gripping force thereof made larger than the gripping force provided by a weight thereof, as a result of the tension spring being extended by an upward movement of the pin member, which is caused by a further rise of the elevatable member.

2. The pickup arm for a prize game machine according to claim 1, wherein the arm is shaped and the pivot portion is positioned in the arm such that when the arm is hung by the weight thereof with the pivot portion being used as the fulcrum, the tip of arm approaches a phantom central line extending in the up-down direction of the pickup arm.

3. The pickup arm for a prize game machine according to claim 1 wherein: the elevatable member is provided around a screw shaft extending in the up-down direction, and a motor rotatable forward and rearward is connected with the screw shaft.

4. The pickup arm for a prize game machine according to claim 2, wherein: the elevatable member is provided around a screw shaft extending in the up-down direction, and a motor rotatable forward and rearward is connected with the screw shaft.

5. The pickup arm for a prize game machine according to claim 3, wherein the motor is located on the same axial line as that of the screw shaft.

6. The pickup arm for a prize game machine according to claim 4, wherein the motor is located on the same axial line as that of the screw shaft.

7. The pickup arm for a prize game machine according to claim 3, wherein the motor is located parallel to the screw shaft.

8. The pickup arm for a prize game machine according to claim 4, wherein the motor is located parallel to the screw shaft.
